(19) United States
(12) Patent Application Publication
(10) Pub. No.: US 2018/0089721 A1
(43) Pub. Date: Mar. 29, 2018

(54) System and Method for Caller Personalization of Mobile Calls

(71) Applicant: Alexandre Abraham, Morumbi (BR)

(72) Inventor: Alexandre Abraham, Morumbi (BR)

(21) Appl. No.: 15/721,218

(22) Filed: Sep. 29, 2017

(30) Foreign Application Priority Data
Sep. 29, 2016 (BR) BR-1020160226805

(51) Int. Cl. G06Q 30/02

(52) U.S. Cl. CPC G06Q 30/0271; G06Q 30/0267

(57) ABSTRACT

The present invention relates to a system and to a method for personalization of mobile phone calls and advertisements therein, whereby personalization is done by the actual caller utilizing the system via selection or creation of content. The system being able to deliver and present content such as still images, video and/or audio prior to and/or after the user receives the call, in addition to advertisement content.

### CROSS-REFERENCE TO RELATED APPLICATIONS

This application claims foreign priority benefits under 35 U.S.C. § 119(a)-(d) to BR-1020160226805 filed Sep. 29, 2016, which is hereby incorporated by reference in its entirety.

### FIELD OF THE INVENTION

The present invention relates to a system and a method for allowing a caller to personalize the mobile phone experience, and for providing personalized advertising content before and/or after said calls through delivery of personalized content during a mobile phone call, whereby such content is selected or created by the actual caller utilizing the system.

### BACKGROUND OF THE INVENTION

In recent years, mobile devices have developed universal appeal as a primary source of information, entertainment and communication. Products for the end user to integrate these devices are created, modified and improved to facilitate consumer access to digital content of all sizes and types.

Thus, consumers are able to communicate and to acquire large amounts of digital content, such as games, television shows, movies and the like with a single click of a button on a smartphone.

This mobile digital environment is a medium particularly suitable for serving targeted advertising before and after phone calls, being able to display still images, video and audio at the time the user receives a phone call.

Systems for providing targeted advertising before and after phone calls are not widely known in the art, but some have been described to provide targeted advertisement in accordance with metadata such as age of the user, gender, location and subject matter with which the user may express affinity.

However, systems capable of allowing callers using mobile phones to personalize the experience of the receiving caller through its own customized content, including advertisement, are not known in the art today.

In addition, targeted advertisements based on metadata can only go so far, and a system for providing personalized advertising before and after phone calls, whereby such content is selected or created by the actual caller utilizing the system, is not known in the art today, possibly due to the lack of realization of such a desire or even its possibility.

This invention meets the gap between automated targeted advertising and advertisement that is directly personalized by a calling user, such as a friend or family member, who would best know the type of content the receiving user would welcome. It does this by meeting the gap in personalized mobile phone calls given content that has been customized by the actual caller.

The U.S. Pat. No. 8,768,294 document discloses a reporting and monitoring system for a mobile device. The system includes a movable application device which is adapted to be stored in mobile device memory. The application after the activation, determining the GPS coordinates of mobile device records digital images over a period of time, sends a predefined message from the mobile device to at least one recipient, preferably an emergency response, such as a station security monitoring, and sends the GPS coordinates and digital images. The coordinates and images can be sent to a remote server for storage and can be accessed by emergency response.

The U.S. Pat. No. 7,769,764 document discloses a mobile advertising system with improved distribution capacity, with applications in mobile installations such as mobile phones. These resources are used to improve the delivery of mobile ads and its distribution, such as associating advertising content with electronic page or desirable mobile communication facilities.

The document US20150058242, in turn, refers to a method for monitoring mobile communication and generate alerts associated with targeted content. A connection is established between the mobile communication device of a monitored user and a mobile communication device from a monitoring user to receive communications for control purposes. The mobile communication device user monitored forwards an incoming or outgoing communication for mobile communication monitoring user device. The mobile communication device monitoring user or monitored user generates an alert if it is determined that the input or output communication contains targeted content, and an alert is provided in the mobile communication device monitoring user.

Also document U.S. Pat. No. 8,364,521 discloses a system with search capability optimized for mobile devices such as cell phones, as well as to improved techniques for delivering content sponsored a mobile communication environment.

US patent US007215750 discloses a method for providing a textual or graphical message to a point of call, utilizing Caller ID database services. The message content is controlled and delivered by the applications server, and can be used as a means of providing advertisements to end users.

Document US20030092432 discloses a caller identification display service and apparatus for providing caller ID functionality in addition to advertisement on a recipient's telephone. The advertisement comes from a database that serves advertisement corresponding to information extracted by the caller identification.

Document US20050165640 discloses a method and system for administering a peer-to-peer marketing program for telecommunications devices such as phones, whereas consumers enroll their phone numbers and earn rewards for receiving advertising content from the system along with caller IDs when receiving phone calls.

Document US20100274624 discloses a method and system for distributing targeted advertisement from an advertisement distributor to an end user's mobile phone, where the system uses end user profile metadata in addition to ratings of the advertisements from other users, to better target the advertisements.

Document U.S. Ser. No. 13/165,079 discloses a system where a peer-to-peer image may be transmitted to a mobile device from a calling user's phone call on a mobile device, and displayed as advertisement on the recipient device. The recipient can then either consume the advertisement or dismiss it by answering the call. However, notably, it also uses targeted advertisement techniques to choose an image based on “the calling user's interest and/or profile”, teaching away from letting the actual calling user personalize the image him or herself.

However, a system for the calling user to personalize the call experience of the receiving user through customized content, including advertisement content, before and after phone calls, said system being able to display audio, images, and video at the time the user receives a phone call; an where such content and/or advertisement is actually selected, created or customized by the actual calling user still remains as a gap in this field of technology.

Thus, there is a continuous and ongoing need for new and improved systems that allow full use of mobile devices such as smartphones to enhance the caller experience and advertising space in ways that users actually welcome the advertisement, as opposed to resenting it.

Embodiments of the present invention respond to this need and to other demands of users by providing the possibility of delivering personalized phone call experiences, in addition to personalized advertisements.

### SUMMARY

According to one embodiment of the invention, a system and a method for customizing and serving personalized content and advertisement before and after mobile phone calls is provided. This system is able to display still images, video and audio at the time the user gets a phone call and the caller is revealed.

In the case of both caller and receiver having the system installed on their smartphones, the system allows customization of the content by the caller. In other words, the originator of the connection may choose a ringtone, audio, and/or image as content, which can be part of an advertisement, that will then appear on the call recipient's phone, so that the content executed during the phone ring is a welcomed surprise for the one who receives the call. The system therefore delivers a personalized advertisement experience that is more relevant and better enjoyed than any computerized targeted system can provide.

In the case that only the receiver has the system installed on their smartphones, or if a personalized content was not selected by the caller, the receiving advertising display can fall back to target advertisements according to parameters such as age of the user, gender, location and subject matter with which the user may express affinity.

Once the receiving user smartphone receives a call and advertising is conveyed, the user can acknowledge via a touch on the screen, and proceed to answer the call normally. After the end of the call, the system can re-display a desired advertisement, new advertisement, or advertisement complementary to what appeared at the beginning of the call.

All advertising content in the system and methods in the present invention are controlled by means of a management area where users can enter, edit and control the amount of time and content to be displayed for each event.

### BRIEF DESCRIPTION OF THE FIGURES

FIG. 1 is a flow chart illustrating the steps of the method according to an embodiment of the invention.

FIG. 2 is a pictorial representation of the system having a set of instructions for causing the system to be performed by the method described herein.

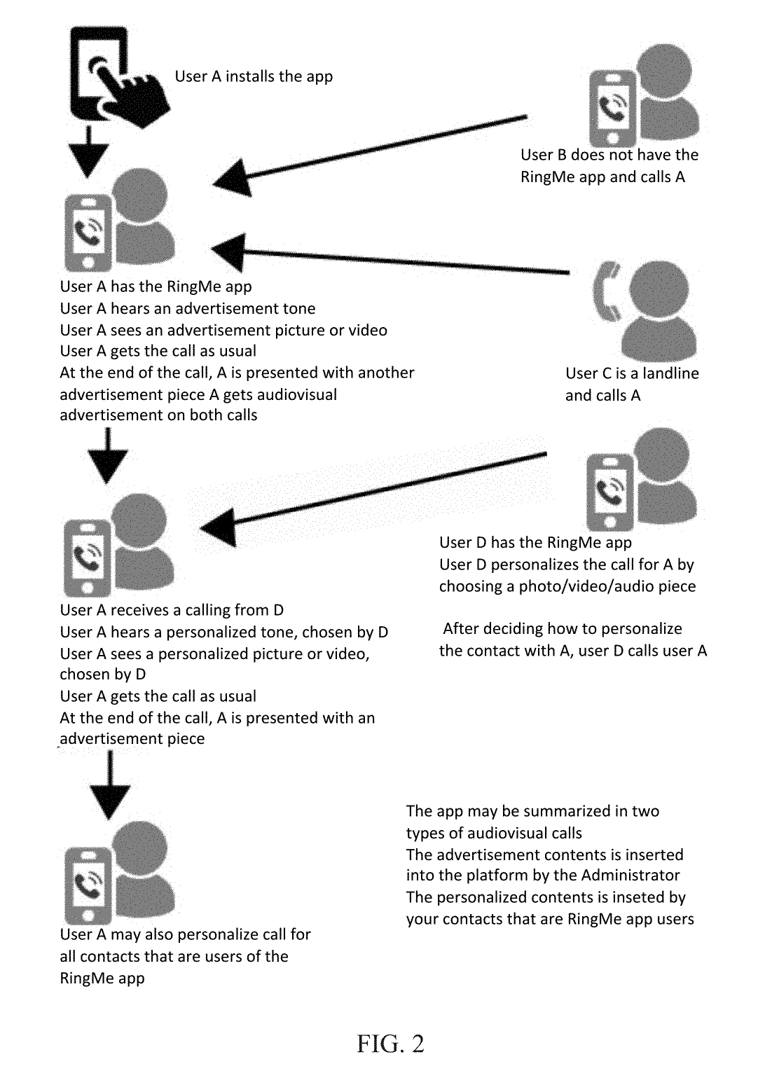

### DETAILED DESCRIPTION

In the following description, for purposes of explanation, specific points are given to provide a thorough understanding of embodiments of the present invention.

It should be appreciated that the particular implementations described herein are illustrative of the invention as its best mode and are not intended to otherwise limit the scope of the present invention in any way.

As will be appreciated by one of ordinary skilled in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the disclosed invention may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented.

The disclosed systems and/or methods may be embodied, at least in part, in application software that may be downloaded from either a website or an “app store” to the mobile device. In another embodiment, the disclosed system and method may be included in the mobile device firmware, hardware, and/or software.

In yet other embodiment, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein. A device embodying any of the elements disclosed herein is said to be a “MARS-enabled” device.

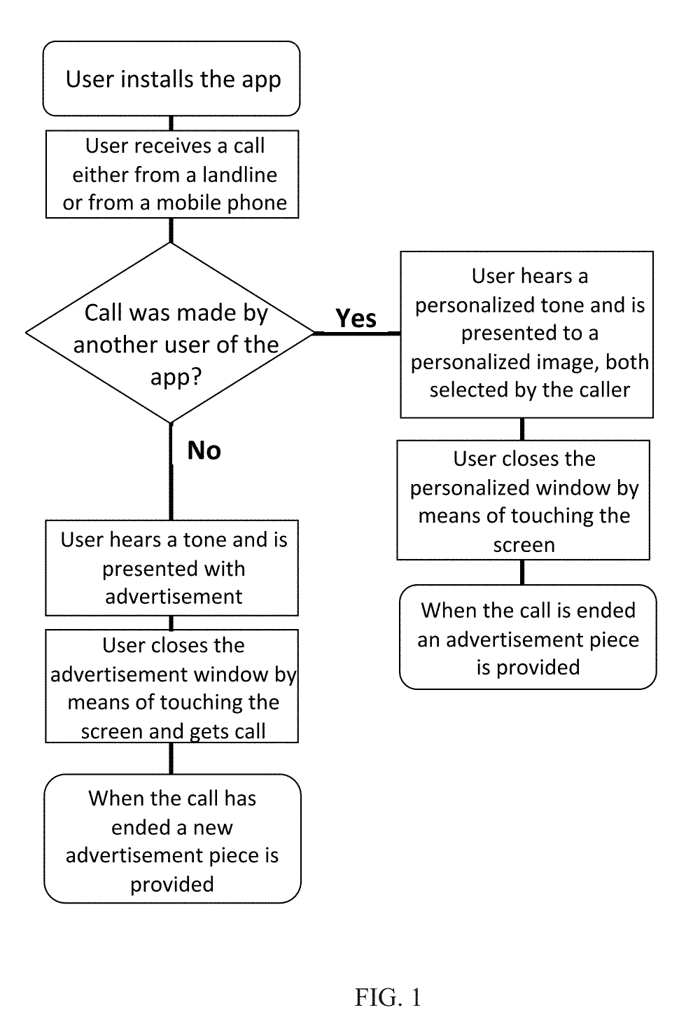

With reference to FIG. 1, an embodiment of the personalized content and advertisement delivery system is presented as between two mobile smartphone devices. The structures according to the present invention are shown in a block diagram/flow diagram form.

According to the current embodiment:

1. A user installs the system on a mobile phone;

2. If the caller makes use of the system according to the present invention, it is able to customize the content that drives the experience of the call, including audio, picture and/or custom video, that may or may not be part of advertisement;

3. In the case both caller and receiver have the system installed, the caller will then enjoy a personalized mobile call receiving experience that is driven by the personalized content created by the calling user;

4. However, when the user receives a call from landline or from a mobile phone where the caller does not make use of the system according to the present invention, the receiver of the call will simply hear non-personalized advertisement;

5. The non-personalized advertisement may still be audio, image or video, that is generic or targeted to the receiving user;

6. After the advertisement is displayed, the recipient proceeds to receive the call in question;

7. Optionally, at the end of the call, the receiver will hear another advertisement content, either generic, targeted, or again personalized by the caller.

The system according to the present embodiment contains two kinds of advertising content, one that is generically entered by a system administrator, and another that is automatically targeted through user metadata. Personalized content, on the other hand, is created, selected, or embedded by the calling user him or herself.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The invention claimed is:

1. A method for personalizing phone calls and advertisement before and after it, characterized by the ability to present a personalized experience at the time the user receives a phone call and comprising the steps of:
Selecting, by a caller, personalized audio, image, or video content; and
Transmitting said personalized content to a receiving phone; and
Presenting said personalized content when the user receives a call; and
Connecting the phone call in question upon acknowledgement of an event.

2. The method in accordance with claim 1, wherein said personalized content is advertising content.

3. The method in accordance with claim 1, wherein said personalized content is joined together with targeted advertising content.

4. The method in accordance with claim 1, wherein said personalized content is replaced by targeted advertising content when personalized content is not available.

5. The method in accordance with claim 1, further comprising the presentation of new advertising content at the end of the call.

6. A system for serving personalized content, including advertisements, comprising:
Installation, by a user, of the system on a mobile phone; and
Selecting, by a caller, personalized audio, image, or video content; and
Transmitting said personalized content to a receiving phone; and
Presenting said personalized content when the user receives a call; and
Connecting the phone call in question upon acknowledgement of an event.

7. The method in accordance with claim 6, wherein said personalized content is advertising content.

8. The method in accordance with claim 6, wherein said personalized content is joined together with targeted advertising content.

9. The method in accordance with claim 6, wherein said personalized content is replaced by targeted advertising content when personalized content is not available.

10. The method in accordance with claim 6, further comprising the presentation of new advertising content at the end of the call.
